(19) United States
(12) Patent Application Publication
(10) Pub. No.: US 2011/0107248 A1
(43) Pub. Date: May 5, 2011

(54) Computer-aided System for Managing and/or Controlling a Building Management System

(75) Inventors: Juergen Blum, Hoechst (AT); Markus Fussenegger, Dornbirn (AT)

(73) Assignee: ZUMTOBEL LIGHTING GMBH, Dornbirn (AT)

(21) Appl. No.: 12/934,256

(22) PCT Filed: Apr. 3, 2009
(86) PCT No.: PCT/EP2009/002469

§ 371 Date: Dec. 9, 2010

(30) Foreign Application Priority Data
Apr. 4, 2008 (DE) 10 2008 017 292.8

(51) Int. Cl. G06F 3/048

(52) U.S. Cl. 715/771

(57) ABSTRACT

In a computer-assisted system for managing and/or controlling a building management system, which system has a plurality of actuators, in particular lamps, sensors and/or command transmitters, which are located in different rooms, a database is provided, in which database information relating to the actuators, sensors and/or command transmitters of the building management system and also data about an axial cell structure of the building are stored. The system is designed to provide a graphical user interface on a display, on which graphical user interface the building and the arrangement of the actuators, sensors and/or command transmitters located in said building are graphically displayed.

The present invention relates to a computer-aided system realized for managing and/or controlling a building management system, the building management system having a plurality of actuators, sensors and/or command transmitters, which are located in different rooms. The actuators can be, in particular, lighting units. The management or operation of air-conditioning devices and shading installations, such as blinds or the like, can also be performed by means of the system.

In larger buildings, particularly office buildings, a multiplicity of different devices are used, by means of which the lighting and the temperature in the various rooms can be set. Since there is frequently a requirement for the operating modes of the various devices to be coordinated with one another, at least substantially, it is usual for all devices to be combined to form a large system, which is managed from a central location. These lighting units, shading installations or air-conditioning devices, which in the following are referred to in general by the term actuators, are in this case connected to a central control unit via a relatively large bus system, it being possible for data to be exchanged via the lines of the bus system. This exchange of data not only serves to transmit control commands from the central control station to the individual actuators, but can also be used to sense the operating state of the individual devices and to emit alarm messages if a fault occurs in the case of individual devices.

A great variety of bus systems, by means of which such an exchange of data can be effected, are known from the prior art. To be mentioned in this connection are, in particular, the Luxmate bus system, developed by the applicant, or the so-called EIB bus (European Installation Bus). In both cases, these are bus systems that, if necessary, can also be combined with other systems. Thus, for example, it is known for sub-sections of the entire bus system to be designed in the form of the known DALI bus, which was designed specially for operating dimmable lamp operating devices.

Various software solutions have already been developed for the purpose of managing and/or controlling such a building management system, which software solutions can be used for systems of greatly differing size and configuration. In such solutions, the data relating to the various actuators of the system is stored in a database, a so-called project file, which additionally also contains data relating to the basic structure of the building. According to the more recent development in building technology, provision is made whereby buildings are described in the context of a so-called axial cell structure. In this case, each story of the building is divided into individual axes, which, in turn, have sub-units, the so-called cells. Actuators and their functions can then be assigned to each individual cell, so as to obtain a logical linking or combination of the various actuators. Individual rooms of the building can then be formed through combination of a plurality of cells, it being possible to combine the actuators of these cells to form groups, for example to enable all lighting units within a room to be operated collectively.

The project file or, in general, the information contained therein, thus describes the entire building management system in a very detailed manner, the system being easily adaptable to new conditions through alteration of the data. Thus, the actuators present within a particular cell can easily be supplemented or reduced, or assigned to other cells. In this case, the information for this purpose is usually represented in the context of a graphical user interface, in which the cells, and the actuators present thereon, are represented in a tabular and/or hierarchical manner.

It has now been found that, although management systems of the type described above are extremely flexible and are suitable for managing and/or controlling a very great variety of building management systems, nonetheless, at the same time, handling is relatively difficult for a user of the system. During the subsequent operation of the system, in particular, monitoring of the operating states of the individual actuators, or collective operation of various sub-groups of actuators, is relatively demanding. In addition, it is frequently the case that messages transmitted from the individual actuators to the central control station can only be assigned to the corresponding actuators in a complicated manner.

The present invention is therefore based on the object of improving management systems for managing and/or controlling building management systems in such a way that handling is simplified for a user of the system.

The object is achieved by a computer-aided system for managing and/or controlling a building management system having the features of claim 1. Advantageous developments of the invention constitute subject-matter of the dependent claims.

The solution according to the invention is based on the concept of expanding the already known systems in such a way that, in addition to the functions already available, a graphical user interface is provided on a display, in which graphical user interface the building and the arrangement of the actuators, sensors and/or command transmitters located therein are displayed graphically.

There is accordingly proposed, according to the invention, a computer-aided system for managing and/or controlling a building management system that has a plurality of actuators, in particular lighting units, sensors and/or command transmitters, which are located in different rooms, the system having a database in which there is stored information relating to the actuators, sensors and/or command transmitters of the building management system and also data about an axial cell structure of the building, the system being realized, according to the invention, to provide a graphical user interface on a display, in which graphical user interface the building and the arrangement of the actuators, sensors and/or command transmitters located therein are displayed graphically.

The system according to the invention is thus designed in such a way that the information, relating to the actuators, sensors and/or command transmitters and to the axial cell structure of the building, that is stored in the database, or project file, is converted by the system in such a way that a graphical user interface can be generated, which represents the structure of the entire system in a significantly clearer manner. In particular, this user interface can now be used for intuitively managing the actuators, sensors and/or command transmitters of the system. For this purpose, for example, provision can be made whereby the user interface provides functions by means of which the group association of the actuators, sensors and/or command transmitters can be altered in a simple and clear manner. The operation of the actuators, for example, is thereby simplified significantly in comparison with the hitherto known hierarchical representation. Operating states of the actuators that are also represented in the user interface can now be used to enable reports relating to malfunctions of individual actuators, sensors and/or command transmitters to be assigned to the respective device in a simple manner.

According to a particularly preferred exemplary embodiment of the present invention, provision is made whereby, in the graphical user interface, the represented information is linked to CAD representations of the building. This enables the configuration of the building management system to be represented particularly clearly.

Further, provision can be made whereby the user can vary an enlargement factor for the representation of the information in the graphical user interface. Details of the building and/or of the various devices can then be represented in dependence on the enlargement factor.

Provision can further be made whereby, in addition to the graphical user interface in which the building is displayed graphically, a further user interface is provided, in which the cells and/or actuators, sensors and/or command transmitters are represented in a tabular and/or hierarchical manner. This further user interface in this case can then be used, in particular, for new definition or new set-up of devices. By means of a special algorithm, the data compiled in this further user interface is then converted into the graphical representation of the building and of the devices.

According to a particularly preferred exemplary embodiment, the display of the system according to the invention is realized as a touch screen. This facilitates yet further the operation of the actuators represented in the graphical user interface.

The invention is to be explained more fully in the following with reference to the appended drawing, wherein:

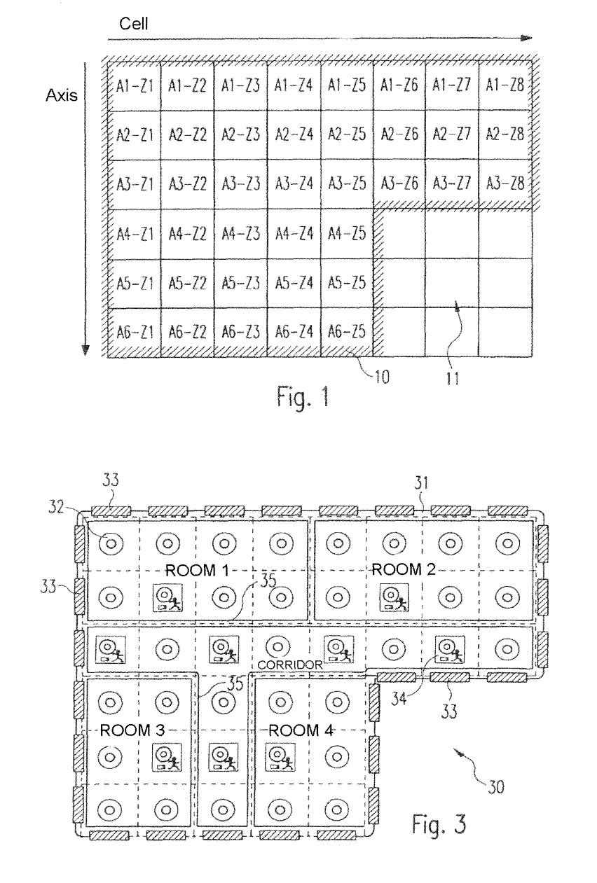

FIG. 1 shows a schematic representation of an axial cell structure of a building having a building management system that is to be managed and/or controlled by means of the system according to the invention;

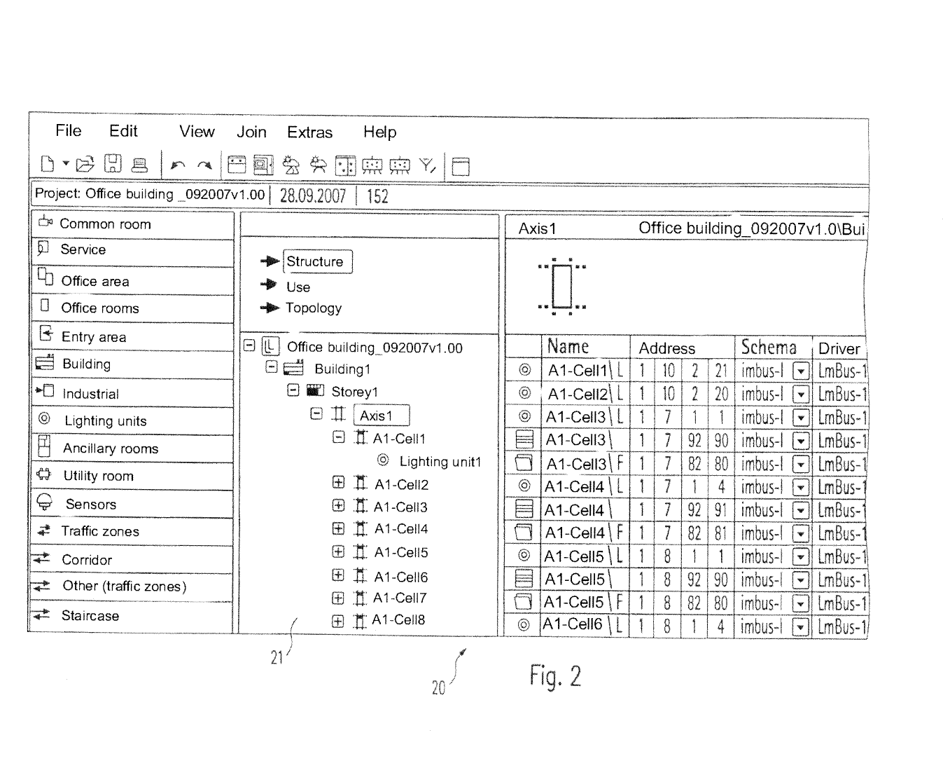

FIG. 2 shows an example of a graphical user interface in which the axial cell structure, and the devices assigned to the individual cells, are represented hierarchically, and

FIG. 3 shows an example of a graphical user interface according to the invention that has been compiled on the basis of the data relating to the actuators and to the axial cell structure of the building.

The hitherto usual description of the type and arrangement of a great variety of devices of a building management system is to be explained first with reference to FIGS. 1 and 2. For this purpose, it is now usual for the structure of a building to be described in the context of a so-called axial cell structure, as represented schematically in FIG. 1.

For this purpose FIG. 1 shows, by way of exempla, a relatively simply structured axial cell structure of a story of a building, wherein, according to the representation, the story is first divided into a plurality of axes—in this case, a total of six axes. Each axis is itself divided, in turn, into individual cells, so as ultimately to span a grid, or matrix, by means of which each sub-region of the story is assigned to an individual cell. According to the representation, each cell in this case is uniquely defined by the number of the axis and the number of the individual cell. It is to be noted in this connection that it is not absolutely necessary for the cells to have a square shape, as represented. Rather, the cells can also have other shapes, in particular a rectangular shape. Further, it is also not necessary for the matrix spanned by the axial cell structure to have an overall rectangular shape. In the case of the exemplary embodiment represented, a clear corner region 11 is provided in the left lower corner of the schematically indicated building outline 10. Since this region 11 is thus outside the building and, accordingly, no actuators are used here, no cells were defined for this region.

For the purpose of describing the structure of the building management system, actuators can now be assigned to the individual cells. For this, FIG. 2 shows a graphical user interface of the type normally used for this purpose. In the context of this user interface 20, a tabular, or hierarchical, representation is given in a first field 21, wherein—as represented—following selection of an appropriate story, an axis (here, the first axis) can be selected. The cells assigned to this axis can then each be selected and managed individually.

It is now possible, by means of the represented user interface 20, to assign a great variety of actuators to the individual cells and to manage these actuators in respect of their use and any association with a group.

The actuators or participating elements of the building management system that are defined in this case can differ greatly in type. Thus, for example, they can be lighting units that, in turn, can be specified in greater detail in respect of their field of application (general workplace lighting unit, emergency lighting unit, etc.). Shading installations, such as blinds, or air-conditioning devices can also be defined in this way and assigned to individual cells. Finally, it is also possible to define sensors (e.g. temperature sensors or brightness sensors) and/or command transmitters (e.g. switches) by means of which at least partially automatic operation or manual operation of the actuators is effected. In addition, information relating to the use of the cells can be defined. In this way, for example, a plurality of cells can be assigned to a common space, e.g. to an open-plan office or to a passageway. Ultimately, this user interface can thus be used to manage all information relating to the participating elements of the building management system.

The representation of the user interface 20 in FIG. 2 also shows, however, that the hierarchical representation used in the new set-up of cells and/or devices is relatively unclear, and makes it more difficult to use the system subsequently in operation. In particular, operation of the actuators, or monitoring of reports or emergency information is, relatively inconvenient.

In order to avoid this disadvantage, according to the invention the management system used hitherto for managing and/or controlling building management systems has been expanded in such a way that the management, but in particular also the control, is simplified significantly by means of a further graphical user interface. An example of this additional user interface is represented in FIG. 3. The core concept of the invention is for the information, relating to the cell-axis structure of the building and to the devices present in the individual cells, compiled by means of the user interface represented in FIG. 2, to be converted into a graphical representation of the building by means of a corresponding algorithm. Accordingly, in the case of the representation according to FIG. 3, the axial cell structure of the building is now no longer in the foreground. Although this is still indicated, it is now primarily the actual shape of the building, and the type and arrangement of the actuators, sensors or command transmitters present therein, that are to be represented. The information for this purpose is derived from the information contained in the project file, the basic procedure for this being as follows.

Firstly, the outline of the building is compiled on the basis of the axial cell structures used. The cells that are used can thus be applied for the purpose of determining and representing the peripheral shape 31 of the building.

In a further step, the type and the arrangement of the previously defined devices are then represented graphically. In the example represented, the project file, for example, contains the information, in respect of the first cell of the first axis (A1-Z1), that one lighting unit and two blinds are provided here, which ultimately results in the representation of a lighting-unit symbol 32 and two blind symbols 33 in the top left corner region of the graphical representation of the building. In comparison with this, an emergency lighting unit and one blind have been assigned, for example, to the seventh cell of the third axis (A3-Z7). Accordingly, in this region of the building, the symbol for an emergency lighting unit 34 and, again, a symbol for a blind are shown. It is to be noted in this connection that the arrangement, particularly of the blind symbols 33, is generated automatically, since the outlines of the building 31 are also taken into account in this case.

In a concluding step, the outline of individual rooms can then additionally be represented on the basis of the usage information relating to the individual cells/actuators. The representation of the resultant walls 35 produces a particularly clear shape. FIG. 3 in this case shows the representation of one story of the building, it also being possible, obviously, to generate and represent an elevation, or side view, of the building in the same manner.

In a further step, additionally, it can be provided that this representation is additionally combined with CAD representations of the building, such that, ultimately, the building with the building management system installed therein can be represented particularly clearly in two dimensions or, if necessary, also in three dimensions.

The new type of graphical user interface according to the invention, represented in FIG. 3, not only serves to improve the representation of the entire building management system, however, but can also be used to control, or manage, the system. For example, actuators or, generally, devices can be specifically selected and operated within the context of the graphical user interface 30. It is also possible for the actuators to be reassigned to new groups, or assigned to new rooms, without the necessity of changing back to the hierarchical representation of the user interface according to FIG. 2 for this purpose. If, for example, the dividing wall between Room 1 and Room 2 is to be altered, this can be effected in a simple manner, through corresponding selection and dragging of the wall, this automatically effecting a corresponding adaptation of the group assignment of the individual actuators. The system is thus easily adaptable to new conditions.

A further advantage of the representation according to the user interface as shown in FIG. 3 is that information transmitted from the devices to a central control station can now be represented very clearly. If, for example, information concerning a malfunction state is emitted by one of the emergency lighting units, it can be learned directly from the representation according to FIG. 3 which lighting unit or which room of the building is affected. Any necessary measures can thus be initiated very much more rapidly and more effectively.

Provision can further be made whereby an enlargement factor for the representation can be set by the user. To enable a clear representation to be achieved, it is provided in this case that the detailed representation of the individual device is adapted to the enlargement factor. For example, it can be provided that, in the case of a general overview of the building, only the most important actuators—for example, the emergency lighting units—are represented, whereas, by contrast, further detailed information about the actuators is displayed only in the case of an enlarged representation. In the case of a relatively high enlargement factor, it can further be provided in this case that, in addition to the actuators, their address information within the bus system can also be displayed in addition. This information can then, for example, also be output in printed form, or exported, in order to generate addressing plans, for use by maintenance personnel, which plans significantly facilitate work on the building management system. The represented graphical symbols for the individual actuators in this case can be adapted at any time to the individual requirements or wants.

According to a particularly preferred embodiment, provision can further be made whereby the representation of the graphical user interface 30 is effected on a touch screen. This provides for particularly simple and intuitive management and/or control of the entire building management system.

1. A computer-aided system for managing and/or controlling a building management system comprising a plurality of actuators, sensors, and/or command transmitters located in different rooms, the system having a database in which there is stored information relating to the actuators, sensors, and/or command transmitters of the building management system and also data about an axial cell structure of the building, wherein the system provides a graphical user interface on a display, in which graphical user interface the building and the arrangement of the actuators, sensors, and/or command transmitters located therein are graphically displayed.

2. The computer-aided system as claimed in claim 1, wherein the graphical user interface enables the actuators, sensors, and/or command transmitters to be managed.

3. The computer-aided system as claimed in claim 2, wherein a group association of the actuators, sensors, and/or command transmitters can be altered by functions provided by the user interface.

4. The computer-aided system as claimed in claim 1, wherein, in the graphical user interface, the represented information is linked to CAD representations of the building.

5. The computer-aided system as claimed in claim 1, wherein an enlargement factor for the representation in the graphical user interface can be varied.

6. The computer-aided system as claimed in claim 5, wherein the representation of details of the building and/or of the actuators, sensors, and/or command transmitters is dependent on the set enlargement factor.

7. The computer-aided system as claimed in claim 1, wherein the system provides a further user interface, in which the actuators, sensors, and/or command transmitters are represented in a tabular and/or hierarchical manner.

8. The computer-aided system as claimed in claim 7, wherein a definition, or new set-up, of actuators, sensors, and/or command transmitters is effected in the further user interface, the data compiled in the further user interface being converted into the graphical representation of the building and of the actuators, sensors, and/or command transmitters, by an algorithm.

9. The computer-aided system as claimed in claim 1, wherein the display is a touch screen.

10. The computer-aided system as claimed in claim 1, wherein an operating state of the actuators, sensors, and/or command transmitters and/or of alarms or reports is represented in the graphical user interface.

11. A computer program product, which, in the case of operation on a computer, provides a graphical user interface for use in a system for managing and/or controlling a building management system according to claim 1.

12. The computer-aided system as claimed in claim 1, wherein the actuators are lighting units.
